(19) United States
(12) Patent Application Publication
(10) Pub. No.: US 2008/0187672 A1
(43) Pub. Date: Aug. 7, 2008

(54) Method and Composition for Improving Adhesion of Organic Polymer Coatings with Copper Surface

(75) Inventor: Zhigang Yu, Shanghai (CN)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/914,472

(22) PCT Filed: May 15, 2006
(86) PCT No.: PCT/US06/18583

§ 371 Date: Nov. 15, 2007

(30) Foreign Application Priority Data
May 16, 2005 (CN) 200510071486.9

(51) Int. Cl. B05D 7/14; C08K 3/30

(52) U.S. Cl. 427/409; 524/423

(57) ABSTRACT

The present invention provides an aqueous solution composition for treating copper surface to improve adhesion of organic polymer with copper surface, characterized in that, said aqueous solution composition comprises water-soluble persulfate and the pH of said composition is from 11-14. The present invention further provides a method for improving the adhesion of organic polymer with copper surface by treating said copper surface and a method for preparing an article having a copper surface which is coated with organic polymer coating. The present composition and method are applicable to the adhesion of any polymer coatings, especially, epoxy, phenolic aldehyde, melamine and polyurea resin on copper surface.

### TECHNICAL FIELD

The present invention relates to the field of coatings. More specifically, the present invention relates to a method for improving adhesion of organic polymer coatings on copper surface through treatment of copper surface, as well as an aqueous solution composition used in said method.

### TECHNICAL BACKGROUND

Due to chemical inertness of copper surface, it is difficult for organic polymer coatings to adhere well to the copper surface. Many methods of treating copper surface, such as organic treatment, sandblast and alloying schemes etc., may improve the adhesion. However, the effects of these methods are not notable. Furthermore, some methods among them are too complicated to be applied broadly.

A lot of patents and papers^{[1,2,3]} disclose copper etching techniques for improving the bond strength of copper and lamination layer in printed circuits and other electronics industries. Many researches have been made on etching technology. However, their technological processes are different from each other. B. J. Love^{[4]} has analyzed the morphology of a copper surface obtained by oxidizing treatment with hot alkaline solution of potassium persulfate. This treatment process included two steps: firstly, the copper foil surface was etched by spraying sodium persulfate for two minutes; and then, the sample was hold in a solution of NaClO₂ and NaOH at 68-71° C. for two minutes.

However, alkaline oxidation method has not been applied in coating industry. Accordingly, a simpler method and composition for etching copper surface to improve the adhesion of organic polymer on copper surface is still needed in the art.

### SUMMARY OF INVENTION

To solve the above problems, the present inventor has developed, with extensive researches, a simple one-step etching method. The adhesion of organic polymer on copper surface is significantly enhanced after the copper surface is treated by this etching method. This pretreatment method can be applied in bonding of copper surface with almost all polymer coatings, especially thermosetting polymer coatings, such as epoxy, phenolic aldehyde, melamine, polyurea and so on.

Specifically, in one aspect, the present invention is to provide an aqueous solution composition for treating copper surface to improve adhesion of organic polymer with copper surface, wherein said aqueous solution composition comprises water-soluble persulfate and the pH of said composition is from 11 to 14.

In another aspect, the present invention is to provide a method for improving the adhesion of organic polymer with copper surface by treating said copper surface. Said method includes the step of dipping said copper surface in an aqueous solution composition or coating said aqueous solution composition onto said copper surface, at the temperature of 35-100° C, until the copper surface becomes black, wherein said aqueous solution composition comprises water-soluble persulfate and has a pH value from 11 to 14.

In yet another aspect, the present invention is to provide a method for preparing an article having a copper surface which is coated with organic polymer coatings, said method comprises the following steps:

a) providing an article having a copper surface on which the organic polymer coating is to be coated;

b) dipping said copper surface in the aqueous solution composition described herein or coating the aqueous solution composition onto said copper surface, at the temperature of 35-100° C., until the copper surface becomes black, wherein said aqueous solution composition comprises water-soluble persulfate and the pH value of said composition is from 11 to 14;

c) coating organic polymers onto said copper surface treated by step b), thereby obtaining an article having a copper surface which is coated with organic polymer coatings.

The present invention also provides an article having a copper surface which is coated with organic polymer coating prepared according to the above method, and the use of the above aqueous solution composition in the treatment of copper surface to improve adhesion of organic polymer with copper surface.

### DESCRIPTIONS OF FIGURES

FIG. 1 shows the morphology change of copper surface by pretreatment, wherein FIG. 1A represents the surface morphology of copper before pretreatment and FIG. 1B represents the surface morphology of copper after pretreatment.

FIG. 2 shows SEM photograph of copper surface with coating removed.

FIG. 3 shows SEM analysis of the interfaces between copper and epoxy coating, wherein FIG. 3A represents an interface without pretreatment, FIG. 3B represents an interface after pretreatment, and FIG. 3C shows an interface which is destroyed after pretreatment.

FIG. 4 shows the adhesion result of epoxy coating on copper surface tested by peeling-off method.

### SPECIFIC EMBODIMENTS

In one aspect of the present invention, it is to provide an aqueous solution composition for treating copper surface to improve adhesion of organic polymer with copper surface. Said aqueous solution composition comprises water-soluble persulfate and the pH value of said composition is from 11 to 14.

The aqueous solution composition of the present invention may further comprise water-soluble sulfate component. In one preferred embodiment, said aqueous solution composition may further comprise other components such as water-soluble polymer, cosolvent, surfactant and so on. Therefore, in one particularly preferred embodiment, the aqueous solution composition of the present invention is consisted essentially of water-soluble sulfate, water-soluble persulfate, water-soluble polymer, cosolvent, surfactant and water. The term “consisted essentially of” as used herein means that said aqueous solution composition may comprise any other component(s) which may exist in any amount, on condition that said component(s) in such an amount has(have) no substantial adverse influence on the effect of the present aqueous solution composition of improving the adhesion of organic polymer with copper surface.

The skilled person in the art may select suitable water-soluble persulfate and water-soluble sulfate based on the well-known knowledge. For example, said water-soluble persulfate may be selected from potassium persulfate, sodium persulfate or ammonium persulfate. Said water-soluble sulfate may be sodium sulfate, potassium sulfate or ammonium sulfate. However, it is within the understanding of the skilled person in the art that, even other water-soluble persulfates and water-soluble sulfates, in addition to those listed above, are used, the purpose of the invention still may be achieved.

The water-soluble polymer which may be used in the aqueous solution composition of the present invention may be preferably selected from polyvinyl alcohol, polyvinylpyrrolidone, polyamide, polyacrylate, polyurethane and so on. The cosolvent which may be used in the aqueous solution composition of the present invention may be preferably selected from isopropanol, ethylene glycol, propylene glycol, glycerin, butyl cellusolve, propylene glycol butyl ether, diethylene glycol methyl ether, dipropylene glycol methyl ether, diethylene glycol methyl ether acetate, N-methyl pyrrolidone, dimethyl ethanolamine and so on. Surfactant may also be added into the aqueous solution composition of the present invention, such as fluorine-containing surfactant, silicon-containing surfactant, aliphatic alcohol polyoxyethylene ether, polyoxyethylene phenol ether, polyoxyethylene alkyl amine, sodium dodecanesulphonate, sodium dodecyl sulfate, fatty glyceride, alanine and so on. The use of cosolvent and surfactant may enhance the penetration of the etching agent in the copper surface.

After determining the components of the present composition, the skilled person in the art may easily determine the proper ratio based on the properties of specifically selected components, so as to achieve the excellent effects of improving the adhesion of organic polymer with copper surface.

In one embodiment of the present invention, said aqueous solution composition comprises usually 0.1-10% (wt), preferably 0.3-5% (wt), more preferably 0.3-2% (wt), even more preferably 0.5-1.5% (wt) of water-soluble sulfate; usually 0.1-20% (wt), preferably 0.3-10% (wt), more preferably 0.8-5% (wt), even more preferably 1-3% (wt) of water-soluble persulfate; 0.1-5% (wt), preferably 0.1-1% (wt), more preferably 0.3-0.8% (wt) of water-soluble polymer; 0.1-10% (wt), preferably 0.5-5% (wt), more preferably 0.8-2% (wt) of cosolvent; 0.01-2% (wt), preferably 0.05-1% (wt), more preferably 0.05-0.3% (wt), even more preferably 0.05-0.2% (wt) of surfactant.

The aqueous solution composition of the present invention may be prepared by any manners well-known by the skilled person in the art. For example, it is possible to add the water-soluble persulfate, such as potassium persulfate, sodium persulfate, ammonium persulfate and so on, in an aqueous solution in which the water-soluble sulfate such as sodium sulfate, potassium sulfate, ammonium sulfate and so on are dissolved. Then, the water-soluble polymer and cosolvent are added into the solution. The solution is agitated until all the components dissolve. Finally, the solution is heated up to 40-90° C. (the etching reaction is not evident if the temperature is lower than 35° C.), and then the surfactant is added. Said surfactant may be anionic or nonionic such as fluorinated surfactants (FC4430, FC4432), polyoxyethylene ether, sodium dodecylsulfonate and so on. At last, the pH value of said composition is conventionally adjusted to be pH 11-14, preferably pH 12-13. The effect is not evident if the pH value is lower than 11. The skilled person in the art may also properly adjust the sequence of the above steps based on specifically selected components.

In another aspect, the present invention provides a method for improving the adhesion of organic polymer with copper surface by treating said copper surface. Said method includes the step of dipping said copper surface in an aqueous solution composition at the temperature of 35-100° C. until the copper surface becomes black, wherein said aqueous solution composition comprises water-soluble persulfate and the pH value of said composition is from 11 to 14. Usually, the copper surface becomes black after dipping in the pretreatment solution for 1-10 minutes under 40-80° C. Then, the copper surface is taken out and dried at room temperature. By this treatment, the copper surface is oxidized into CuO, Cu₂O and CuS, which enhances affinity with polymer groups.

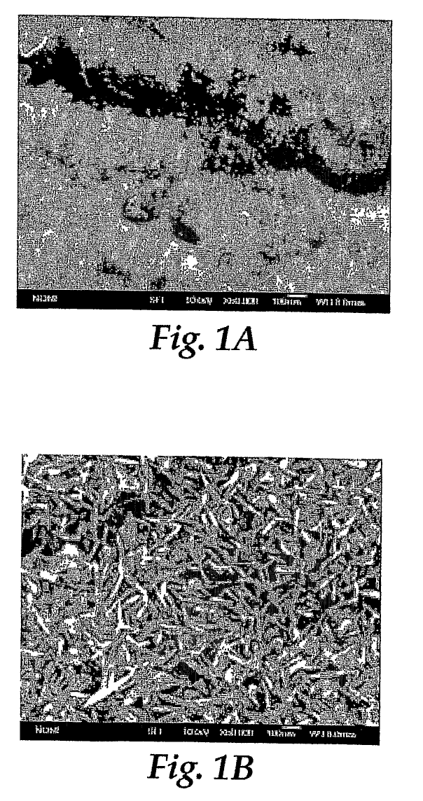

Through SEM investigation, the inventor finds out that a regular spiculate crystal microstructure is formed on the copper surface (FIG. 1). Compared with the similar structure reported in the prior art, this microstructure is more subtle and the crystal size is tinier. The length of the spiculate crystal is about 200 nanometers. This porous rough microstructure provides uniform conjoint points and thus the inter-penetration and anchor-hold between the polymer molecule and the copper surface are improved. As a result, the present invention further provides a structure of copper surface having spiculate crystal with a length of about 200 nanometers.

After the treatment of copper surface as above, organic polymer coating may be coated onto the treated copper surface by conventional coating techniques. The polymer used herein includes polyacrylates, amine resin, phenolic resin, alkyd resin, polyamide, epoxy, polyurethane, melamine, polyurea, organic silicon resin, fluoro-resin and so on. The coatings may be water-based, solvent-based, free of solvent or in powder state. The coating methods may be brush coating, spray coating, dip coating, roller coating, coil coating or other methods.

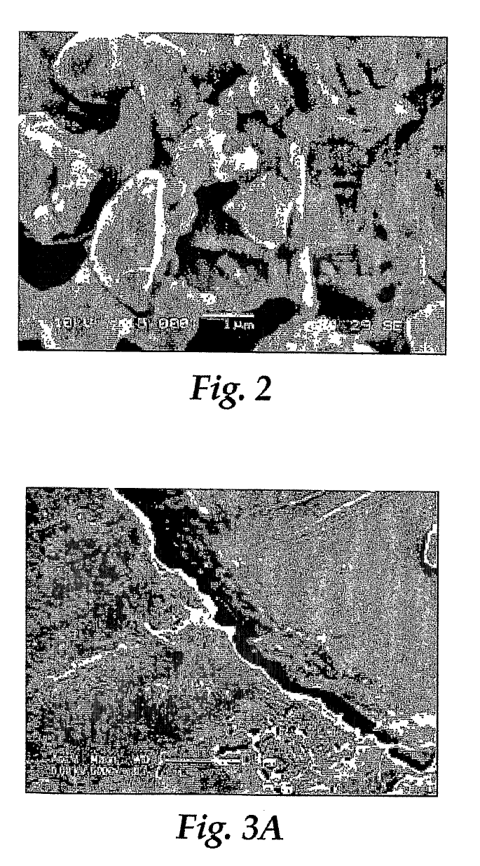

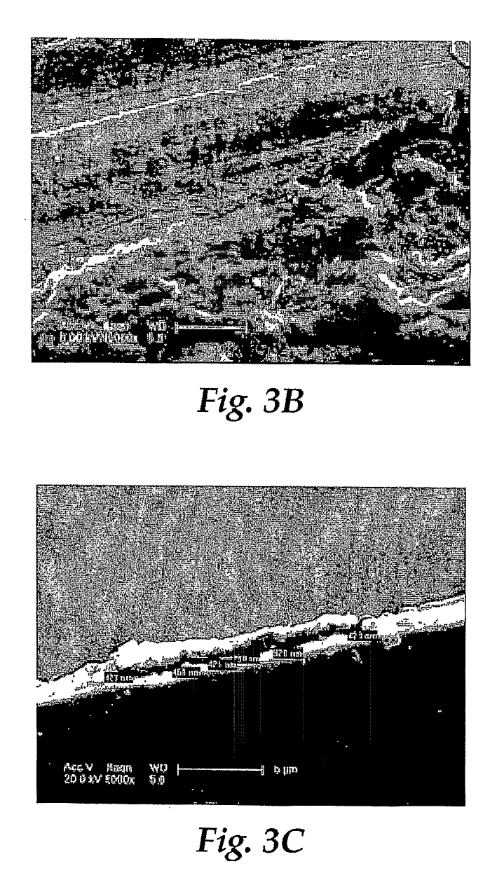

An example of epoxy powder is provided as follows. The bonding result of polymer coating and copper surface can be clearly observed by analyzing the microstructure of copper surface with epoxy coating removed (FIG. 2) and the interface on the cross section of copper and coating (FIG. 3). The epoxy coating is removed by calcination in nitrogen atmosphere at 700° C. for 30 minutes and then rubbing out the residual carbon on the surface. The transverse section of the copper and coating is obtained by crosscutting the coated copper sheet. FIG. 2 shows that there is still some residue on the copper surface after removal of the coating, demonstrating the bonding between the copper and the coating. From FIG. 3A, it can be found that there is a gap of about 1-2 μm in width at the interface of the copper and the coating, while in FIG. 3B, no gap is found at the interface for the pretreated sample. FIG. 3C displays an in-between transitional layer at the interface, which binds these two parts closely even under outer force. Until now no research has reported this specific microstructure and interface between copper and organic coating, which results in much better adhesion between the copper and organic coating. Additionally, this interface structure may also be deemed as a proof of the effect caused by the treatment method of the present invention. It is the first time for the method of present invention being used in coating industry for improving the adhesion of polymer coating on the surface of copper substrates, including brass, red copper, bronze and other copper alloys. Compared with other surface modifying methods including primer coating, the present method has several advantages including simple operation, low cost, high efficiency and environmental safety. Furthermore, it hardly imposes any negative effects on the properties of polymer coating and the copper material.

Next, the present invention will be further described by reference of examples. However, it should be understood that these examples are exemplified for the purpose of illustration but not limitation on the invention. Unless otherwise stated, all the “%” in the examples means “% weight”.

### EXAMPLES

### Example 1

1 g of Na₂SO₄ was added in 100 g of water, and then 2 g of (NH₄)₂S₂O₈ was added slowly until they dissolved completely. Then, 0.5 g of PVA1799 (Shanghai Petrochemistry) and 1 g of glycerol were added. The solution was heated up to 60° C. After the components dissolved, 0.1 g of FC4432 (3M) was added. The pH value of the pretreatment solution was adjusted to about 12-13.

The copper sheet was dipped into the pretreatment solution at 60° C. for 5-10 minutes. When the copper surface became black, the copper sheet was taken out and dried at room temperature.

Then, the copper sheet was heated up to 200° C. and put into epoxy powder (3M 521) fluid bed for 2 seconds. It was then taken out, kept at ambient temperature for 2 minutes, and cooled by water rinsing, so as to obtain a cured cross-linked coating.

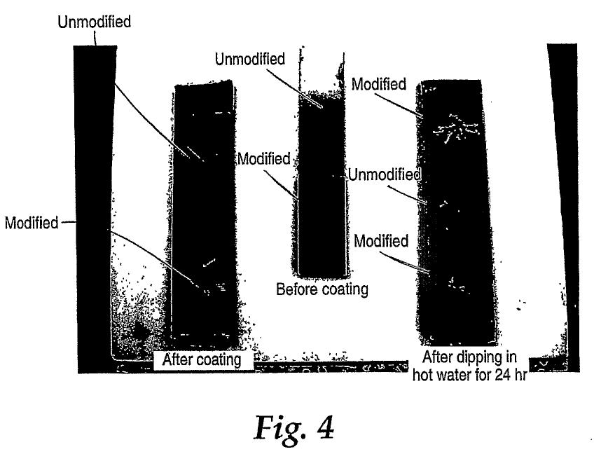

Adhesion was tested according to the Standard of CSAZ245.20-98. The coatings in scribed areas were peeled off by a knife. The test results were shown in FIG. 4. Even being soaked in hot water (95° C.) for 24 h, the treated area was found hard to peel off, while almost the whole coating was removed easily in the untreated area. The adhesion was improved from Level 5 to Level 1.

The inventor compared, by Elcometer adhesion tester, four samples obtained for adhesion by different pretreatment methods, which are no pretreatment, air-blast clean treatment, method reported in the Reference^{[4]} and the present pretreatment, respectively. The results were listed in Table 1. The present pretreatment technique gave the highest adhesion strength which was much higher than the similar method reported in the reference^{[4]}.

TABLE 1
Adhesion strength with different pretreatment methods

| Copper pretreatment method | Adhesion strength (MPa) |
|---|---|
| No pretreatment | <5, can be removed by hand |
| Air-blast clean | 8.9 |
| Method in reference^{[4]} | 13.7 |
| Present method | >20, outside the test range |

Table 2 showed the adhesion strength results of Instron Tensile Test. These results further confirm the conclusion of the present invention that the present pretreatment method could significantly enhance the adhesion of epoxy coating on copper surface, which was much better than that of the previously reported methods.

TABLE 2
Adhesion strength results by Instron Test

| | Adhesion strength (MPa) |
|---|---|
| No pretreatment | 17.8 |
| Method in Reference^{[4]} | 11.1 |
| Present method | 37.4 |

### Example 2

Example 1 was repeated, except that (NH₄)₂S₂O₈ was replaced by K₂S₂O₈. The adhesion test result was Level 1.

### Example 3

Example 1 was repeated, except that PVA was replace by PA25 (polyacrylates, BASF). The adhesion test result was Level 1.

### Example 4

Example 1 was repeated, except that propylene glycol was replaced by propylene glycol butyl ether. The adhesion test result was Level 1.

### Example 5

Example 1 was repeated, except that FC4432 was replaced by Surfynol504. The adhesion test result was Level 2.

### Example 6

Example 1 was repeated, except that FC4432 was replace by DA168 (Huntsman). The adhesion test result was Level 2.

### Example 5

The pretreatment process was the same as that in example 1. Then, aqueous polyurethane (WSD3002, Shanghai Heda Polymer Technical Ltd.) was coated by brush and then cured at 100° C. for 5 mins. The adhesion test result was improved from Level 2 to Level 1.

### Example 7

The pretreatment process was the same as that in example 1. Then, alkyd resin (cured with amine resin, weight ratio: MD372/586=2/1, Dongguan Juncheng Chemical Engineering) was coated by brush and then cured at 120° C. for 5 mins. The adhesion test result was improved from Level 3 to Level 1.

### Example 8

The pretreatment process was the same as that in example 1. Then, thermoset polyacrylates (BD803, Shanghai Xinda Chemical Plant) was coated by brush and then cured at 120° C. for 5 mins. The adhesion test result was improved from Level 4 to Level 1.

### Example 9

The pretreatment process was the same as that in example 1. Then, fluoropolymer dispersion (THV340C, 3M) was coated by brush and then cured at 150° C. for 5 mins. The adhesion test result was improved from Level 6 to Level 4.

### Example 10

A pretreatment solution was prepared as described in Example 1. Then, the pretreatment solution was coated onto the copper surface and dried by air. Epoxy was coated onto the copper surface as Example 1 and the adhesion test result was Level 2.

Although specific embodiments have been disclosed as above, it is apparent for the skilled person in the art to make various changes and modifications without departuring the scope and spirit of the present invention. All the variations within the scope of inventions are therefor covered by the appended claims.

### REFERENCES

1. JP62185884, Lamination of copper and resin for printed-circuit boards.
2. Chemija,1990(2), 120-8, Russian, The correlation between roughness and adhesion was discussed.
3. JP03171794, Manufacture of multilayer wiring board.
4. Journal of Adhesion,1993,40(2-4), 139-150, Effects of surface modifications on the peel strength of copper-based polymer/metal interfaces with characteristic morphologies.

1. An aqueous solution composition for treating copper surface to improve adhesion of organic polymer with copper surface, characterized in that, said aqueous solution composition comprises water-soluble persulfate and the pH of said composition is from 11-14.

2. The composition of claim 1, wherein said composition is essentially consisted of water-soluble sulfate, water-soluble persulfate, water-soluble polymer, cosolvent, surfactant and water.

3. The composition of claim 2, wherein said water-soluble sulfate is selected from sodium sulfate, potassium sulfate and ammonium sulfate, and said water-soluble persulfate is selected from potassium persulfate, sodium persulfate and ammonium persulfate.

4. The composition of claim 2, wherein said water-soluble polymer is selected from polyvinyl alcohol, polyvinylpyrrolidone, polyamide, polyacrylate, polyurethane; said cosolvent is selected from isopropanol, ethylene glycol, propylene glycol, glycerin, butyl cellusolve, diethylene glycol methyl ether, dipropylene glycol methyl ether, diethylene glycol methyl ether acetate, N-methyl pyrrolidone, dimethyl ethanolamine; and, said surfactant is selected from fluorine-containing surfactant, silicon-containing surfactant, aliphatic alcohol polyoxyethylene ether, polyoxyethylene phenol ether, polyoxyethylene alkyl amine, sodium dodecanesulphonate, sodium dodecyl sulfate, fatty glyceride, and alanine.

5. The composition of claim 2, wherein said composition comprising 0.3-2 wt % of water-soluble sulfate, 0.3-10 wt % of water-soluble persulfate, 0.1-1 wt % of water-soluble polymer, 0.5-5 wt % of cosolvent, and 0.05-0.3 wt % of surfactant.

6. A method for improving the adhesion of organic polymer with copper surface by treating said copper surface, said method including the step of dipping said copper surface in the aqueous solution composition of claim 1 or coating the aqueous solution composition of claim 1 onto said copper surface, under the temperature of 35-100° C., until the copper surface becomes black, wherein said aqueous solution composition comprises water-soluble persulfate and the pH of said composition is from 11-14.

7. A method for preparing an article having a copper surface which is coated with organic polymer coating, said method comprises the following steps:
a) providing an article having a copper surface on which the organic polymer coating is to be coated on;
b) dipping said copper surface in the aqueous solution composition of claim 1 or coating the aqueous solution composition of claim 1 onto said copper surface, under the temperature of 35-100° C., until the copper surface becomes black, wherein said aqueous solution composition comprises water-soluble persulfate and the pH of said composition is from 11-14;
c) coating organic polymer onto said copper surface treated by the step b), thereby obtaining said article having a copper surface which is coated with organic polymer coating.

8. The method of claim 7, wherein said organic polymer is selected from polyacrylate, amine resin, phenol aldehyde resin, alkide resin, polyamide, epoxy, polyurethane, melamine, polyurea resin, organosilicon and fluororesin.

9. An article having a copper surface which is coated with organic polymer coating prepared according to the method of claim 7.

10. The use of the aqueous solution composition of claim 1 in the treatment of copper surface to improve adhesion of organic polymer with copper surface.
